(19) United States
(12) Patent Application Publication
(10) Pub. No.: US 2016/0170502 A1
(43) Pub. Date: Jun. 16, 2016

(54) Device for adjusting and self-testing inertial sensors, and method

(71) Applicant: Robert Bosch GmbH, Stuttgart (DE)

(72) Inventors: Rainer Dorsch, Dettenhausen (DE); Christian Haubelt, Kritzmow (DE); Thomas Claus, Tuebingen (DE); Rudolf Bichler, Reutlingen (DE); Lars Middendorf, Rostock (DE)

(21) Appl. No.: 14/962,881

(22) Filed: Dec. 8, 2015

(30) Foreign Application Priority Data
Dec. 12, 2014 (DE) 10 2014 225 677.1

(51) Int. Cl. G06F 3/0346; G06F 3/03

(52) U.S. Cl. CPC G06F 3/0346; G06F 3/0304

(57) ABSTRACT

A device includes a camera, a processing unit, and at least one inertial sensor. The processing unit is set up to determine a first movement profile of the device from movement data of the at least one inertial sensor. The processing unit is set up to determine a second movement profile of the device from image data of an object observed using the camera.

### BACKGROUND OF THE INVENTION

1. Field of the Invention

The present invention relates to a device having a camera, a processing unit, and at least one inertial sensor, the processing unit being set up to determine a first movement profile of the device from movement data of the at least one inertial sensor.

2. Description of the Related Art

Such devices are known for example as smartphones or digital cameras. The inertial sensors of a smartphone are adjusted during production, in a final test. For reasons of cost, frequently only a minimal adjustment is carried out, which limits the precision. A further reduction in precision results from installation (soldering) of the sensors in the smartphone. This loss of precision can be corrected during the smartphone final test through subsequent calibration, which however increases costs and increases demands on production. The precision that can be achieved is limited, in particular if the inertial sensors are to be used in applications such as indoor navigation. If a plurality of inertial sensors and further input devices, such as a camera, are combined, the different runtimes (latency) of the signals within the system also cause deviations that have to be taken into account in the evaluation. In particular for applications in the area of augmented reality, for this reason a temporal adjustment of the camera and the inertial sensors is also necessary. In addition, it is necessary to carry out a self-test for example for diagnostic purposes with the inertial sensors in the field.

### BRIEF SUMMARY OF THE INVENTION

The object of the present invention is to improve the calibration and the self-testing of inertial sensors using a camera.

The present invention is based on a device having a camera, having a processing unit, and having at least one inertial sensor, the processing unit being set up to determine a first movement profile of the device from movement data of the at least one inertial sensor. The core of the present invention is that the processing unit is set up to determine a second movement profile of the device from image data of a two-dimensional object observed using the camera, having a regular, multiply recurring image pattern.

Here, it is advantageous that a self-test, or also a calibration, of the at least one inertial sensor is possible using the camera, without further test equipment. Advantageously, the self-test and calibration are possible in normal operation, i.e. without additional test costs during production. Advantageously, repeated testing in order to compensate adverse environmental conditions and aging is possible. An advantageous embodiment of the present invention provides that the processing unit is set up to determine a second movement profile of the device from image data of a two-dimensional object observed using the camera, having a regular, multiply recurring image pattern. Advantageously, in this way a second movement profile can also be reliably created if the opening angle of camera 100 is small enough that only a segment of two-dimensional object 400 having a few complete image patterns 410 can be taken.

An advantageous embodiment of the present invention provides that the processing unit is set up to compare the second movement profile with the first movement profile. An advantageous embodiment of the present invention provides that the processing unit is set up to provide an item of adjustment information for an adjustment of the inertial sensor from a comparison of the first movement profile with the second movement profile. An advantageous embodiment of the present invention provides that the inertial sensor is a rotational rate sensor, and that the processing unit is set up to provide adjustment information for an offset calibration of the rotational rate sensor from a comparison of the first movement profile with the second movement profile. An advantageous embodiment of the present invention provides that the processing unit is set up to determine the sensitivity of the at least one inertial sensor. A particularly advantageous embodiment of the present invention provides that the device is a smartphone, and the processing unit is a processor unit of the smartphone having a corresponding software unit (app). A particularly advantageous embodiment of the present invention provides that the corresponding software (app) can determine and compensate the latency of the camera and inertial sensors through correlation.

The present invention also relates to a method for adjusting and self-testing inertial sensors, as well as to a computer program product.

The present invention is intended to support the precise calibration and the self-testing of inertial sensors, in particular in a smartphone, using the camera of the smartphone. In particular in the case of rotational rate sensors, the offset calibration and the determination of the sensitivity can be improved. The self-testing of the inertial sensors can also be greatly improved. Particularly advantageous is the use of templates and the main camera of the smartphone for these tasks. The present invention also relates to a method for compensating the latency between the camera and the at least one inertial sensor.

### BRIEF DESCRIPTION OF THE DRAWINGS

FIG. 1 shows a device according to the present invention.

FIG. 2 shows a two-dimensional object, i.e. an image having an image pattern.

FIG. 3 shows a method according to the present invention for adjusting and self-testing inertial sensors.

FIG. 4 shows a first movement profile of a rotational rate sensor and a second movement profile of a camera, in a comparison.

### DETAILED DESCRIPTION OF THE INVENTION

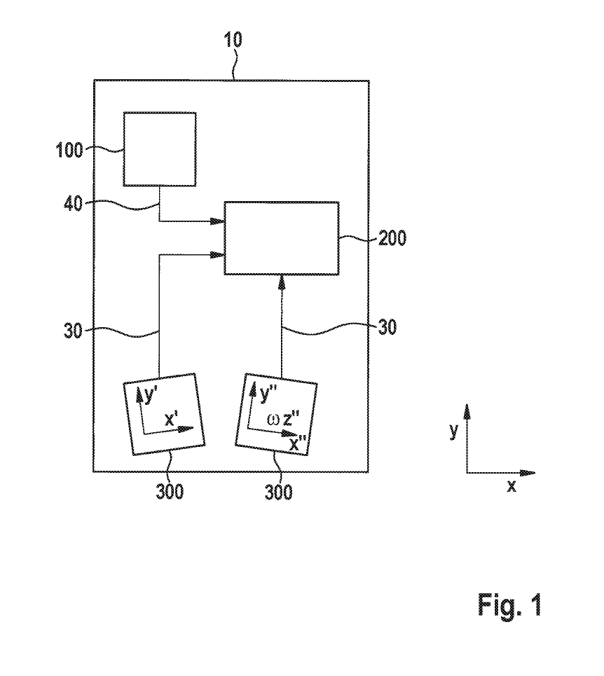

FIG. 1 shows a device according to the present invention. Shown is a device 10 having a camera 100, having a processing unit 200, and having as an example a first inertial sensor 300 and a second inertial sensor 300. Processing unit 200 is set up to determine a first movement profile 320 of device 10 from movement data 30 of inertial sensors 300. The processing unit can be for example a control device, or also a microcontroller having corresponding software. The processing unit can in particular be the processor unit of a smartphone having suitable software (app). Inertial sensor 300 can for example be an acceleration sensor, a magnetic sensor, or also a rotational rate sensor. Combined sensor systems of a plurality of these, or also additional, sensors are also possible. In this example, the first inertial sensor is an x, y acceleration sensor, and the second inertial sensor is z rotational rate sensor. Due to the installation of the sensors in the device with limited precision with regard to their position and orientation, the respective coordinate system (x′, y′, z′), (x″, y″, z″) of the sensors is slightly different from the coordinate system (x, y, z) of the device itself. In the present example, the first inertial sensor therefore actually has the sensing directions x′, y′ for accelerations. The second inertial sensor has sensing direction z″, for which reason it detects a rate of rotation about the axis z″. According to the present invention, processing unit 200 is set up to determine a second movement profile 420 of device 10 from image data 40 of a two-dimensional object 400 observed using the camera, having a regular multiply recurring image pattern 410. In addition, processing unit 200 is set up to compare second movement profile 420 with first movement profile 320. In this way, the orientation errors of the inertial sensors can be recognized and correspondingly compensated. Moreover, the sensitivity of the inertial sensors can be determined. In addition, the latency between the camera and the inertial sensors can be determined, and can be compensated by shifting one of the two measurement series.

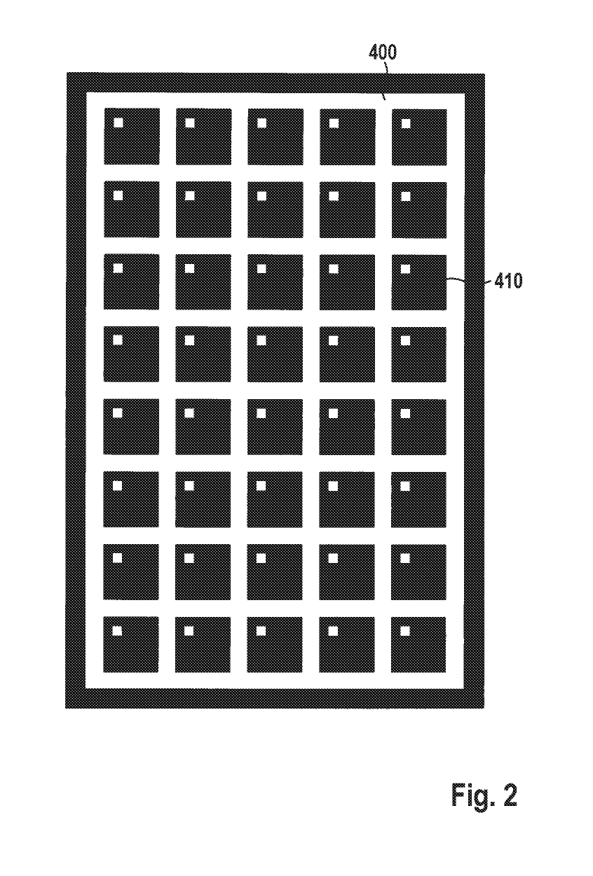

FIG. 2 shows a two-dimensional object, i.e. an image having an image pattern. Shown is a two-dimensional object 400 having a regular, multiply recurring image pattern 410. Image pattern 410 is repeated multiple times in both directions of extension of two-dimensional object 400. In this way, a second movement profile can be reliably produced even when the opening angle of camera 100 is so small that only a segment of two-dimensional object 400 having few complete image patterns 410 can be recorded.

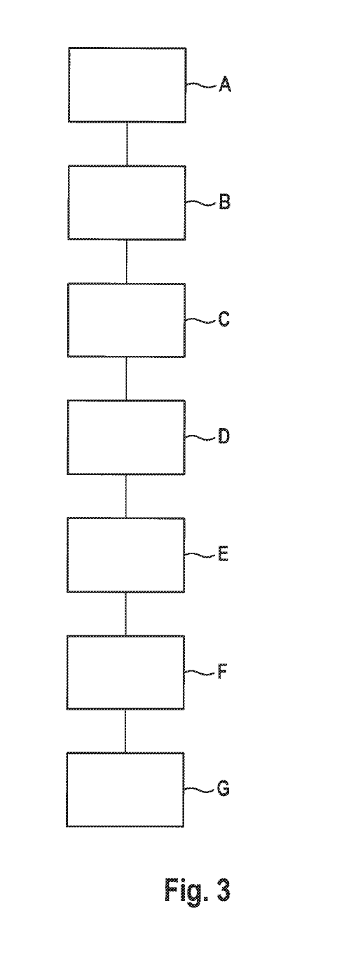

FIG. 3 shows a method according to the present invention for adjusting and self-testing inertial sensors.

According to the present invention, the method includes the steps:

A—Provision of a device 10 having a camera 100, having a processing unit 200, and having at least one inertial sensor 300.

B—Provision of an object 400.

C—Movement of the device relative to object 400, camera 100 continuously observing two-dimensional object 400 at least at times, and/or at least partially;

with

D—Recording of movement data 30 of the at least one inertial sensor 300 and recording of image data 40 of camera 100.

E—Determination of a first movement profile 320 of device 10 from movement data 30 of the at least one inertial sensor 300; and

F—Determination of a second movement profile 420 of device 10 from image data 40 of camera 100.

Optionally, in a step G, a comparison of first movement profile 320 and second movement profile 420 with one another takes place continuously during the method, or subsequent to the method.

From the result of this comparison, the sensitivity of the at least one inertial sensor 300 can be determined. Inertial sensor 300 can be calibrated, or adjusted, with regard to the magnitude of the signal and the sensing direction.

In an exemplary embodiment, in step B an object 400 is provided, in particular having a regular, multiply recurring image pattern 410.

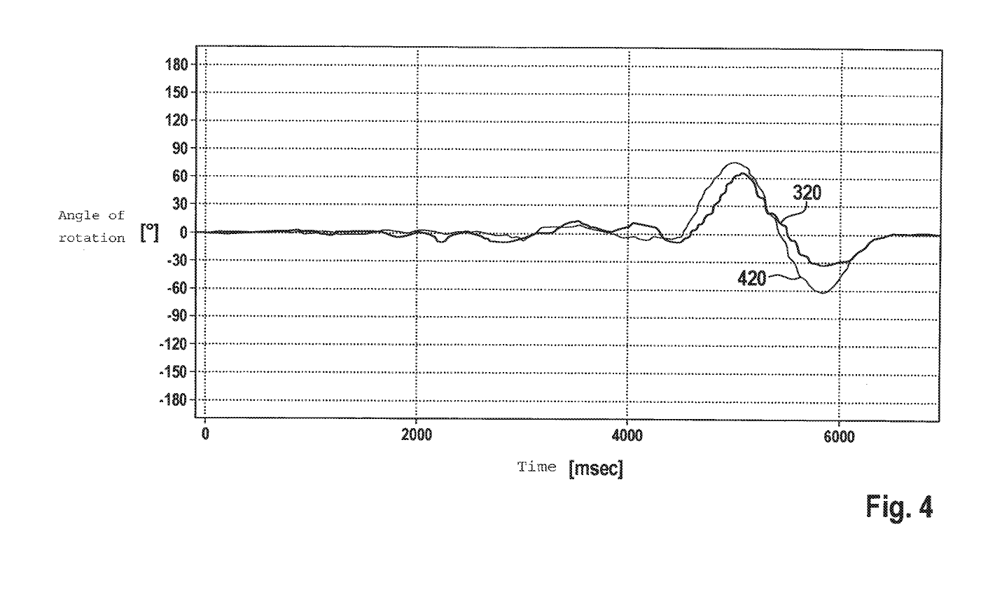

FIG. 4 shows a first movement profile of a rotational rate sensor and a second movement profile of a camera, in comparison. Through comparing first movement profile 320 and second movement profile 420, the calibration parameters of the rotational rate sensor, e.g. offset and sensitivity, as well as the latency between the camera and the inertial sensors, can be determined.

A concrete example application for the present invention is a smartphone having a camera and inertial sensors. On the smartphone, a software application is started having the menu points “calibration of the inertial sensors” and “self-testing of the inertial sensors”. The smartphone is then panned, with its main camera, over a specific image pattern, as shown in FIG. 2. During this, the measurement data of the inertial sensors are recorded, and the first movement profile is created. In parallel, using the camera, and with the aid of image processing, the movement of the smartphone is acquired and is converted into the coordinate system of the inertial sensors. Here, the second movement profile is created. By comparing the first movement profile with the second movement profile, i.e. through correlation of the movement curves of the measurement values of the inertial sensors and the calculated movement via the camera images, and a modeling of the sensors, the calibration parameters, e.g. offset and sensitivity of the inertial sensors, as well as the latency between the camera and the inertial sensors, in particular for rotational rate sensors, can be determined. The procedure for the self-test function is very similar. A possible example of a software interface is shown in FIG. 4. The required image pattern can easily be attached electronically to devices and programs, and printed, for users.

What is claimed is:

1. A device comprising:
a camera;
a processing unit; and
at least one inertial sensor;
wherein the processing unit is configured to (i) determine a first movement profile of the device based on movement data of the at least one inertial sensor, and (ii) determine a second movement profile of the device based on image data of an object observed using the camera.

2. The device as recited in claim 1, wherein the second movement profile of the device is determined based on image data of a two-dimensional object observed using the camera, the two-dimensional object having a regular, multiply recurring image pattern.

3. The device as recited in claim 2, wherein the processing unit is configured to compare the second movement profile with the first movement profile.

4. The device as recited in claim 3, wherein the processing unit is configured to provide an item of adjustment information for an adjustment of the at least one inertial sensor based on a comparison of the first movement profile with the second movement profile.

5. The device as recited in claim 3, wherein the at least one inertial sensor is a rotational rate sensor, and the processing unit is configured to provide an item of adjustment information for an offset calibration of the rotational rate sensor based on a comparison of the first movement profile with the second movement profile.

6. The device as recited in claim 2, wherein the processing unit is configured to determine the sensitivity of the at least one inertial sensor.

7. A method for self-testing an inertial sensor, comprising:
(A) providing a device including a camera, a processing unit, and at least one inertial sensor;
(B) providing an object;
(C) providing movement of the device relative to the object;
(D) during the movement of the device relative to the object, (i) continuously observing the object by the camera at least at selected times, (ii) recording movement data of the at least one inertial sensor, and (iii) recording image data captured by the camera;
(E) determining a first movement profile of the device based on the movement data of the at least one inertial sensor; and
(F) determining a second movement profile of the device based on the image data captured by the camera.

8. The method as recited in claim 7, wherein in step (B), a two-dimensional object having a regular, multiply recurring image pattern is provided.

9. The method as recited in claim 8, further comprising:
(G) comparing the first movement profile and the second movement profile with one another.

10. The method as recited in claim 9, wherein a latency between the camera and the at least one inertial sensor is determined through correlation of the first movement profile and the second movement profile.

11. The method as recited in claim 10, wherein the latency between the camera and the at least one inertial sensor is compensated.

12. A non-transitory, computer-readable data storage medium storing a computer program having program codes which, when executed on a computer, perform a method for self-testing an inertial sensor, the method comprising:
(A) providing a device including a camera, a processing unit, and at least one inertial sensor;
(B) providing an object;
(C) providing movement of the device relative to the object;
(D) during the movement of the device relative to the object, (i) continuously observing the object by the camera at least at selected times, (ii) recording movement data of the at least one inertial sensor, and (iii) recording image data captured by the camera;
(E) determining a first movement profile of the device based on the movement data of the at least one inertial sensor; and
(F) determining a second movement profile of the device based on the image data captured by the camera.
